(19) United States
(12) Patent Application Publication
(10) Pub. No.: US 2010/0176583 A1
(43) Pub. Date: Jul. 15, 2010

(54) Book with flexible slanted spine

(76) Inventor: Eric Stanley Reiter, Pacifica, CA (US)

Correspondence Address: ERIC STANLEY REITER, 251 NELSON Avenue, Pacifica, CA, 94044, US

(21) Appl. No.: 12/455,904

(22) Filed: Jun. 9, 2009

Related U.S. Application Data
(60) Provisional application No. 61/204,851, filed on Jan. 10, 2009.

(51) Int. Cl. B42D 3/00; B42D 3/02

(52) U.S. Cl. 281/35; 281/29; 281/36

(57) ABSTRACT

A book with a slanted parallelogram cross section and a single film of clear plastic wrapped around its covers and spine has the advantage of a stronger and more flexible spine than a conventionally shaped paperback book. This advantage is due to a longer glue spine, and its bound pages being exposed to glue at a thin face strip in addition to its page edge. The slant angle is typically acute at 35 degrees from the front cover. A slantbind book can remain open and flat whereas a conventional paperback needs to be held open. The slanted spine offers a manufacturing advantage because the wedge shaped spine of a glued book block can be fed between spring loaded rollers to apply a clear film around the book to form its book covers. The film may be a heat activated laminating film or a wide tape-like pressure sensitive adhering film. The film helps strengthen the book spine while preserving its flexibility. The invention affords all sheets including graphics for the book covers to be printed from a single low cost printer.

### CROSS-REFERENCE TO RELATED APPLICATIONS

Provisional patent U.S. application No. 61/204,851, filing date Jan. 10, 2009, of Eric Stanley Reiter, titled Bookbinding with slanted spine.

### REFERENCE TO MICROFICHE APPENDIX

Not applicable

### TECHNICAL FIELD

This invention relates to the field of bookbinding.

### BACKGROUND OF THE INVENTION AND PRIOR ART

In prior art bookbinding, a style generally known as a paperback book or a perfectbind book, is typically manufactured from a stack of rectangular preprinted sheets of paper that are stacked directly atop each other to become a book block, glue is applied to an edge of this paper stack to form the book spine, and a wrap-around paperboard cover is applied. The book block with cover are typically trimmed at its unglued three edges at the final stage of book manufacture. A typical paperback book spine is not flexible, and the reader must bend the pages to open the book. A typical glued spine paperback book is clumsy to read. Attempts in prior art toward making a paperback book spine more flexible by use of glued-in signatures and use of thinner book cover material have met limited success.

The present invention relies upon a slanted book spine and strengthening the spine and cover sheets with a film of plastic. Slanted paper stacks are known in prior art. In prior art a slanted book block is also called “shingled,” and a slanted fore edge is called “fanned.” However, applying such a slanted paper stack toward making a book spine stronger and more flexible has not been recognized.

U.S. Pat. No. 848,680 Writing-Paper Tablet by L H Nelson, Apr. 2, 1907 outlines a slanted spine for paper to be torn from a tablet, and not for a bound book. Nelson did not elaborate his method or apparatus toward the needs of a bound readable book. Nelson did not specify any means of attaching a book cover, and there was no discussion of how a slanted spine would make a binding more flexible. It can be seen from Nelson's FIG. 2 that his tablet spine was stiff and not intended to bend, because the paper is shown to bend instead of the spine. It is not obvious from Nelson's work that slanting a spine enhances strength and flexibility; in fact Nelson demonstrated the opposite: an inflexible slanted book spine. Furthermore, Nelson's specification and claims describe removable sheets only, and did not elaborate on the theme of permanently bound pages. Therefore the notion that combining two known ideas—namely, (1) a slanted spine and (2) a wrap-around book cover—would be thought from prior art to make a book with a wrap-around cover and an inflexible spine. Therefore it is not obvious to combine those two ideas and expect to have a book spine with enhanced flexibility.

U.S. Pat. No. 1,765,194 Temporary book of sheets by A Von Auw, Jun. 17, 1930 outlines a slanted spine, again for paper to be torn from a tablet and not for a bound book. Von Auw did not design a book with any spine flexibility or page-holding strength due to its slanted spine attribute. This work made no indication that a slanted spine would enhance its flexibility or strength.

U.S. Pat. No. 1,932,153 Method in the manufacture of catalogues, pamphlets, or the like with slanting opening edges by J S F Bergendahl, Oct. 24, 1933 describes a book with a slanted fore edge. The spine was straight the way most books are. This work describes a “lightning index” of page markings at the book fore edge. A slanted fore edge is an optional component of the present invention, and is not a required component.

U.S. Pat. No. 2,455,971 Bookbinding and method of producing the same by J F Bosche, Dec. 14, 1948 describes slanting a paper stack in a manufacturing step for a glued book spine. The resulting glued book spine is at a right angle.

U.S. Pat. No. 4,673,324 Method and sheet for binding pages by G R Hansen and G R Rabuse, Jun. 16, 1987 describes a book spine to be bound with tape and calls for shingled sheets at the book spine. However, the spine is not flexible at all and requires the sheets to do all the bending.

U.S. Pat. No. 5,013,200 Binding system by R A Hunder et al, May 7, 1991 describes in a manufacturing step to temporarily slant a spine for applying tape between sheets. The spine shape is returned to a conventional right angle stack.

The fact that paper stacks with slanted spines have been considered in various contexts, yet have not been developed for permanent flexible-spine bookbinding is evidence that the present invention is not obvious.

### OBJECTS OF THE INVENTION

One object of the present invention is to provide a unique book geometry with spine flexibility comparable to a hard bound book, but as inexpensive to produce as a paperback book. Shingling the paper sheets to form a slant at the book spine actually makes the spine more flexible. A slanted edge book block with a surrounding and adhered cover sheet of paper or plastic film strengthens the book spine.

Another object of the invention is to provide a book design with enhanced page holding strength, yet is still inexpensive to manufacture.

Another object of the invention is to provide a book design that simplifies manufacture of a book with printed durable covers. The acute angled edge of a slanted book spine can fit between pinch rollers of a hot laminator machine thereby more easily laminating the book spine as well as its covers. Therefore the printed first and last sheets of a book block contain the cover graphics at reduced cost. A special printer for handling larger and thicker cover stock is not required if the wrap-around film version of the present invention is implemented. This is especially useful for a print-on-demand book-making machine.

Another object of the invention is to provide a method of slanting a paper stack and manufacturing a book with a slanted spine.

Another object of the present invention is to provide a book with a slanted fore edge that occurs as a fringe benefit of manufacturing a slanted spine. A slanted fore edge has two advantages: (1) its pages are easier to turn and thumb through, and (2) bleed-printing creates markings that are easy to see at the fore edge for finding marked pages.

Another object of the present invention is to provide a binding spine that has more area exposed for printed information. It is difficult to read the print on a thin conventional spine, such as on a conventional perfectbind magazine, whereas the spine of a bound journal with a slanted spine is wider and can contain larger print. When shelved, a slanted title strip of a thin book is easier to find, display, file, and pull from the shelf. This is especially useful for thin bindings stacked with their spines upwards in a file cabinet.

Yet another object of the invention is to provide a method of re-binding a conventional paperback book into a slantbind book, to make the book easier to open and read.

Of major advantage to book sellers is that a book with slanted spine is unique upon display due to its shape. This is a non-trivial object of the invention. A book with slanted spine will be recognized in book stores and promote its sale.

### SUMMARY OF THE INVENTION

In the present invention, a slantbind book, the preprinted paper sheets are not stacked directly atop each other prior to the gluing operation, but are slightly shifted atop each other at the edge to be glued so as to form a slant at the book spine. When viewing the glued paper stack, edge-on, at an edge side perpendicular to its glue spine, the glued paper stack, also known as a book block, will appear as a parallelogram. The solid shape of the book is a parallelepiped. The slanted spine will have a layer of flexible glue applied and can be reinforced with a support layer of paper or fabric. Each paper sheet in this slanted book block will be exposed to glue on a very thin strip on one of its faces as well as on its edge. Paper in such a slanted book block will have greater adhesion to the spine, and the spine will have greater flexibility to allow its spine to be sharply and repeatedly bent open with less failure than a conventional square bound paperback book. One may argue that such a slanted book spine would suffer from its title strip having less exposure on a book shelf. However, a title strip even steeper than 45 degrees is still easily visible on a conventional book shelf. For greater ease of viewing the title strip, a taller font may be chosen.

For extra strength and creation of a book cover, the glued slanted book block can have a film of clear plastic wrapped around and adhered to its front cover, slanted spine, and back cover. This is most efficiently accomplished with hot lamination film technology. The slanted spine aids in feeding the book block between hot laminator rollers. Alternatively, pressure activated clear tape may be applied to wrap around the book covers and spine. The top and bottom parallelogram shaped edges of the paper stack will be trimmed to remove excess plastic film. The slanted covered book block is now a book with flexible slanted spine.

A method of manufacturing a book block with a slanted spine is known in prior art and involves clamping and bending a paper stack over a curved jig. The bending exposes a slant that can be glued and prepared in a variety of ways to manufacture a book. The curved jig method will not work with thick paperboard because it will impart a permanent bend.

The preferred method of slantbind book manufacture is an automated sequence of repeatedly clamping and bending a paper stack in shallow bends until the desired spine slant angle is achieved. This method leads to a machine design that can adapt to a wide range of paper sizes, book block thicknesses, and spine slant angles.

Toward desktop publishing applications, the development of low-cost desktop printers with large memory and duplex printing has eliminated the need for clumsy mechanical collating and folding. What has yet to be developed is a form of book to best takes advantage of desktop printing technology. An office with a machine to slantbind books would not require a larger printer to produce a book cover that a prior art perfectbind method would require. The laminated first and last sheets of the book block can become the covers. A slantbind book simplifies print-on-demand book manufacturing by introducing a fundamental change to the shape of the book itself.

### DESCRIPTION OF FIGURES

FIG. 1 is a finished book with slanted spine, viewing its parallelogram cross section.

FIG. 1A is a magnified section of the spine of the book of FIG. 1.

FIG. 2A is a clamp and bend mechanism for slanting a paper stack.

FIG. 2B is a slanted paper stack having its slanted spine edge glued.

FIG. 2C is a slanted paper stack having a paper title strip applied.

FIG. 2D is a slanted paper stack being fed into a pair of pinch rollers for laminating.

FIG. 3 is a section of an end view of finished book with a single wrap-around paperboard cover.

FIG. 4 is a magnified cross sectional view of a slantbind book spine fully opened.

FIG. 5 is a shelf with slanted bottom displaying slantbind books.

FIG. 6 details the method of slanting a paper stack by a sequence of shallow bends.

### PREFERRED EMBODIMENT

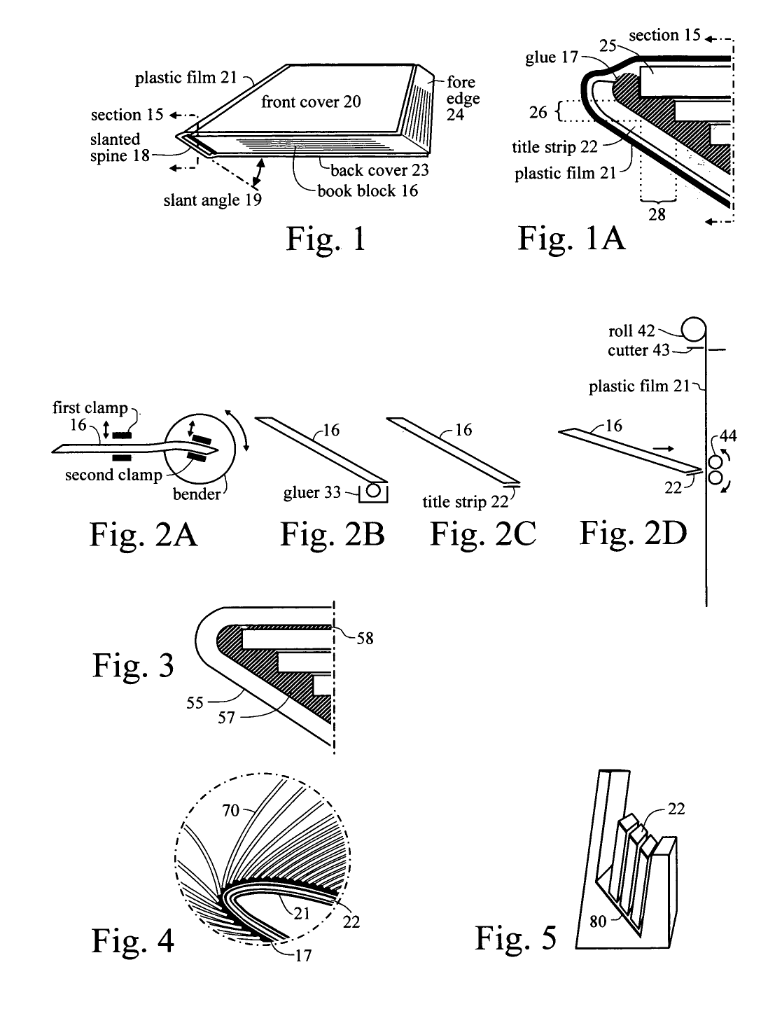

FIG. 1 is a perspective view of a typical finished slantbind book. FIG. 1A shows a close up view of FIG. 1 at the tip of its spine, marked section 15. Book block 16 is a paper stack slanted to a parallelogram cross section that contains the printed book contents. Book block 16 is bound at its slanted spine with layer of glue 17. Glue is on paper edge 26 of each paper sheet of the book block and its cover stock sheets. A thin strip 28 on the face of each paper sheet will be adhered with glued to add adhesion strength. Slanted spine 18 is at slant angle 19, shown at 34 degrees from front cover 20. Front cover 20 is composed of clear plastic film 21, part of which is heat laminated to the first sheet of the printed book block. This first sheet is paper of thicker cover stock 25 collated in to help make a harder cover. Plastic film 21 also covers printed paper title strip 22 bound to glue 17, and back cover 23. Plastic film 21 serves to strengthen slanted spine 18. Back cover 23 has paper of thicker cover stock collated in at the last sheet of book block 16. This book structure lends itself to a cover that does not need to be printed separately on a larger special printer. The cover can be printed on the same machine as the sheets of the book block, yet become a durable and pretty cover.

Typically slanted spine 18 will be hidden when viewing front cover 20; otherwise the title would be redundant from the front. This orientation of the parallelogram also sets the fore edge to be visible for a page marking feature, the so called lightning index. Though known in prior art, the lightning index is a fringe benefit of manufacturing a book with parallelogram cross section. As an option, fore edge 24 may be trimmed square. With slant angle 19 oriented to front cover 20 as shown in FIG. 1, slant angle 19 is called an acute angle. With the front and back cover reversed, slant angle 19 is called an obtuse angle. An obtuse angle slantbind book is easier to open pages at its fore-edge without holding the book, offering an advantage for children's books. Slant angle 19 can be any angle substantially differing from 90 degrees of a typical book, and within reasonable manufacturing limits. A typical acute slant angle is in the range of 15 to 45 degrees. A typical obtuse slant angle is in the range 135 to 165 degrees.

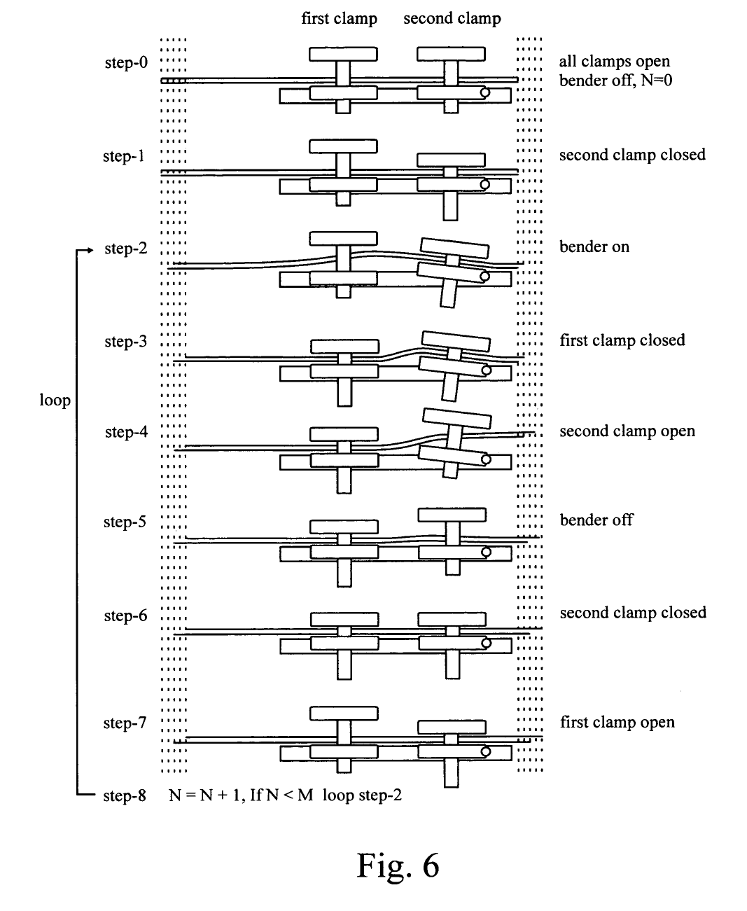

A method of manufacturing a parallelogram shaped book with a wrap-around film cover will now be outlined with reference to FIG. 2. In prior art, a shingled edge on a stack of paper is accomplished by clamping and bending the paper stack. However, such a method can permanently bend thicker cover stock. The preferred method of shingling, not known in prior art, is to perform a sequence of shallow clamp-and-bend operations until the final slant angle is obtained. A machine with clamps arranged as in FIG. 2A under computer control can then be programmed to generate a wide range of slant angles without resort to re-tooling. Detail of the bending method will be described below with reference to FIG. 6. Arrows indicate motion of the first clamp, second clamp and bender parts. The next step is to glue the spine, with gluer 33 shown in FIG. 2B. FIG. 2C shows the pre-printed paper title strip 22 being pressed onto the wet glue over the slanted spine. The glue technology employed is not critical, but the glue must cure flexible. Polyvinyl acetate (PVA) glue has been tested to work well. With PVA, a hot iron applied to title strip 22 can cure the glue fast enough to not slow down subsequent manufacturing steps. Hot glue technology also works well. In FIG. 2D a measured length of clear plastic film 21 is fed from roll 42, and cut with cutter 43, at a size to fit the spine and covers. This film will strengthen the cover sheets and book spine. Plastic film 21 may be either clear hot laminating film or clear pressure sensitive adhering tape-like film. Thickness of the laminating film is best at 0.005 inch. Plastic film 21 will hang before a pair of counter rotating pinch rollers 44, and book block 16 can be fed into plastic film 21 to wedge the film and itself between pinch rollers 44. Pinch rollers 44 are both gear driven, and are spring loaded against each other to allow the book block to fit between them. A commercial laminator machine with a wide spring loaded roller extension may be utilized in this process. A conventional rectangular cross section book block could not be fed between pinch rollers in so easy a manner. For hot laminating, pinch rollers 44 are heated and four rollers are often used. After the film is adhered, the book will be trimmed at its parallelogram edges to remove excess film and make the parallelogram edges look smooth. The remaining fore edge 24 need not be trimmed if the film is accurately cut and placed before pinch rollers 44. However, the fore edge may be optionally trimmed.

Illustrating another embodiment of the invention, FIG. 3 shows a section of an end view of a book with a wrap-around cover of paperboard. This book is similar to a conventional paperback book, but with a slanted spine. I have performed tests with similar paper and glue, constructed to make a book with a slanted spine and a square spine, and have found that the geometry of a slanted spine alone will make the spine more flexible. Cover stock 55 is wrapped around and adhered with glue 57 to the shingled paper edges of the book block, and to the first and last sheets of the book block with layer of glue 58. By gluing the cover stock to the first and last pages of the book block, the covers become thicker and stiffer at the front and back covers where it is desirable. This scheme of gluing to the first and last sheets of the book block also reduces the problems of inaccurately applied glue at the inside cover seams, and the possibility of poorly adhered first or last book block sheets. Use of layer of glue 58 at the first and last book block sheets is optional. The book of FIG. 3 is very similar to a perfectbind book, but with a slanted spine. After the cover stock is adhered, the book will be trimmed at its parallelogram cross section edges. The fore edge need not be trimmed if the cover stock is accurately cut and placed before gluing. The fore edge may be optionally trimmed.

This simple book design of FIG. 3 is not known or obvious in prior art. It is not predicted by the work of Nelson (1907) because a single wrap-around cover was not specified, and Nelson did not demonstrate that a slanted spine would enhance spine flexibility.

### Advantages of a Slanted Spine

FIG. 4 is a magnified cross section of the finished slantbind book of FIG. 1, viewing its spine fully bent open while pages 70 are opened for reading the book. A high magnification digital photograph of a slantbound book spine was used as a template to computer-draw all components and thickness to scale. Pages 70 were 0.005 inch thick. Title strip 22, glue 17, and plastic film 21 are the same components as shown in FIG. 1. The strength and flexibility of books constructed by the slantbind method have been tested. From tests in comparison with prototypes constructed with the same type of paper and glue, the pages require more force to be torn from a book with slanted spine than from a conventional square spine. Additionally a slanted spine is capable of folding to a sharper angle without spine damage. Therefore the mechanical stress in the binding is decreased when the book is bent to open. The slant in the spine lets it bend open easier. The bending of the spine reduces the need for the pages to bend, and a slantbind book spine remains stable in its open position. A prototype of a slanted spine book has been tested to open and lie flat in the open position to a degree comparable to a conventional signature-sewn hard-bound book. This is a great advantage over conventional perfectbind books. Perfectbind books do not remain flat and open without permanently stressing and damaging its spine. When bending the spine of a slantbind book, spine glue 17 will stretch and be in tension while title strip 22 and plastic film 21 will be in compression. When the spine is bent, the distance per sheet of spine glue 17, being longer than in a conventional square spine, can expand more per sheet for a given spine bending angle. A slanted spine provides a greater spine width so that the bend per page is reduced when the book is opened. Another advantage of the slanted geometry is that layers within a paper sheet parallel to the plane of the paper are not spread apart as the spine is opened; stress is taken up by stretching the corner shaped glue between sheets to allow the book block to open and lie flat. This corner shaped glue section is marked 26 28 in FIG. 1A. Coated paper stock may not adhere well on thin strip 28 (see FIG. 1 ) without chemical, abrasive, or electrical corona treatment, but non-coated paper needs no special treatment. The slantbind method remains advantageous because when a slanted spine is bent open for page reading, the radius of spine bend is longer, and therefore glue stress is relieved.

There is an additional advantage to a book with slanted spine from the standpoint of shelving. FIG. 5 is a display shelf with slanted bottom 80 whereby the spines of a stack of slantbind books are more easy to read and grab for filing purposes. With such a shelf, slantbind title strips 22 are easier to read and sort through. This is especially useful for thin slantbind magazines where more area is desired for the title strip. If a conventional horizontal bookshelf is used, slanted bookends can shift a stack of slantbind books so that title strips will all lie in the same plane. On a conventional horizontal shelf without any special bookends, slantbind title strips at 35 degrees are still easily viewable, even when mixed with conventional books. A slantbind book is easy to find among conventional books on a book shelf.

### Method of Slanting a Book Block

FIG. 6 details the method of slanting a book block by incremental shallow bends, performed by the apparatus outlined in FIG. 2A. Nine steps are shown in FIG. 6, step-0 to step-8. Only two paper sheets are shown in a simplified stack for clarity. The papers are initially squared in place atop each other. The stack is actually bent twice per bending cycle by second clamp: during a bender twist, and when the bender straightens to flatten the stack. Therefore in a small angle approximation each bending cycle slants the stack approximately 2Φ and an approximation of the number of bending cycles may be calculated. In practice, the final slant angle Θ will be determined by operating the machine and counting each bending cycle N until the desired slant angle Θ is obtained to find the maximum number of bending cycles M. With Φ chosen small, angles will add up to provide a selection of final slant angles and not deform thicker paperboards. The ability to handle a wide range of slant angles Θ and thicker stock is an important advantage over prior art methods.
Step-0: All clamps open, bender off. Bender is straight.
Step-1: Second clamp closed.
Step-2: Bender on. Bender twists stack by increment degree Φ.
Step-3: First clamp closed.
Step-4: Second clamp open.
Step-5: Bender off. Bender is rotated to the straight position.
Step-6: Second clamp closed. Second clamp is activated to flatten the stack. Spine edge has now had approximately two of increment degree Φ added to its slant.
Step-7: First clamp open.
Step-8: N=N+1, If N<M loop step 2. Step-2 through step-7 are performed M times to deliver the final slant angle Θ.

After the final slant angle is achieved the clamps may still be used to support the book block in the remaining operations outlined in FIG. 2. For each loop through step-2 through step-7 the entire stack will be shifted slightly toward the right in FIG. 6. The steeper the slant, the stronger the book.

The particulars of the slanting method are: the frame of reference, position of the bender pivot point, radius of bend, size of clamps, and distance between clamps. Adjustment of any of these particulars will effect such things as the degree of spine-slant per stack bending angle, and range of paper size.

### Conclusions Ramifications and Scope

In the context of the slantbind method it will be appreciated that the following variations on its theme are predicted. Any book may be converted to a slantbind book by cutting off its spine and gluing the book at a slant. A slantbind book block may have either a hard cover or soft cover applied to it. There are many ways to bend a stack of paper to create a slanted edge and then glue it to manufacture a slanted spine. A computer automated slantbind machine introduces a wealth of artistic expression to the bookbinder. The slant angle may be either an acute or obtuse angle. A wide range slant angles are appreciated. Spines may be bound with extremely sharp angles for specialty applications. A book block bent to generate a compound slant such as a saddle shape geometry is predicted. Oppositely slanted book blocks may be joined to create “V” or notch shaped book spines. The bending step may be applied asymmetrically to create a slanted spine edge with a compound or conical curve. Use of sheets other than paper, such as plastic or thick paperboard, is obvious. Slantbind lends itself to books rolled up and mailed in a tube and to cylindrical shaped books. Any flexible strip of material may be prepared with glue and pressed upon a slanted stack edge to create a flexible book spine.

The following claims are to be interpreted in their broadest sense.

I claim:

1. A book comprising:
(a) a book block with a slanted parallelogram cross section composed of multiple sheets including a front cover sheet and a back cover sheet,
(b) a title strip fitting and adhering with flexible glue onto a slanted edge of said book block to form a glued slanted spine, and
(c) a single sheet fitting the book on three sides and adhering to said title strip, said front cover sheet, and said back cover sheet,
whereby said single sheet and its adhering sheets form a book cover and a flexible slanted spine of said book block.

2. The book of claim 1 wherein said single sheet is clear heat activated laminating film.

3. The book of claim 2 wherein said glued slanted spine is oriented at an acute angle with respect to said front cover sheet.

4. The book of claim 2 wherein said glued slanted spine is oriented at an obtuse angle with respect to said front cover sheet.

5. The book of claim 1 wherein said single sheet is clear pressure sensitive adhering film.

6. The book of claim 5 wherein said glued slanted spine is oriented at an acute angle with respect to said front cover sheet.

7 The book of claim 5 wherein said glued slanted spine is oriented at an obtuse angle with respect to said front cover sheet.

8. A book comprising:
(a) a book block with a slanted parallelogram cross section to expose a slanted spine edge, and comprised of multiple sheets including a first sheet and a last sheet, and
(b) a single sheet of cover stock fitting said book block on three sides and adhered with a glue layer to said slanted spine edge,
whereby said single sheet of cover stock and its adhered sheets form a book that is flexible at said slanted spine edge.

9. The book of claim 8 wherein said slanted spine edge is oriented at an acute angle with respect to said first sheet.

10. The book of claim 8 wherein said slanted spine edge is oriented at an obtuse angle with respect to said first sheet.

11. The book of claim 8 wherein said single sheet of cover stock is additionally adhered with a glue layer to said first sheet and said last sheet of said book block.

12. The book of claim 11 wherein said slanted spine edge is oriented at an acute angle with respect to said first sheet.

13. The book of claim 11 wherein said slanted spine edge is oriented at an obtuse angle with respect to said first sheet.

14. A book with a slanted flexible spine manufactured by binding a block of sheets and a cover film comprising the steps:
(a) slanting said block of sheets into a book block with parallelogram cross section to expose a slanted spine edge,
(b) gluing said slanted spine edge with a layer of flexible glue,
(c) pressing a preprinted title strip that fits said slanted spine edge onto the glue of said slanted spine edge before the glue cures,
(d) rolling said cover film onto said preprinted title strip, the first sheet of said book block, and the last sheet of said book block, and
(e) trimming the parallelogram cross section edges of the covered book block,
whereby the glued covered book block is a book with a flexible slanted spine.

15. The book of claim 14 wherein said cover film is clear heat activated laminating film.

16. The book of claim 15 wherein manufacturing step (a) of slanting further includes a first clamp upon said book block, a second clamp upon said book block, and a bender to twist said second clamp in an iterative process inserting steps comprising:
(f) tightening said second clamp,
(g) twisting said bender and second clamp to an increment angle,
(h) tightening said first clamp,
(i) loosening said second clamp,
(j) twisting said bender to the straight position,
(k) tightening said second clamp,
(l) loosening said first clamp, and
(m) repeating steps (g) through (l) until a desired slant angle is achieved.

17. The book of claim 14 wherein said cover film is clear pressure sensitive adhering film.

18. The book of claim 17 wherein manufacturing step (a) of slanting further includes a first clamp upon said book block, a second clamp upon said book block, and a bender to twist said second clamp in an iterative process inserting steps comprising:
(f) tightening said second clamp,
(g) twisting said bender and second clamp to an increment angle,
(h) tightening said first clamp,
(i) loosening said second clamp,
(j) twisting said bender to the straight position,
(k) tightening said second clamp,
(l) loosening said first clamp, and
(m) repeating steps (g) through (l) until a desired slant angle is achieved.
